(19) United States
(12) Patent Application Publication
(10) Pub. No.: US 2019/0087783 A1
(43) Pub. Date: Mar. 21, 2019

(54) MODEL-BASED RECOMMENDATION OF TRENDING SKILLS IN SOCIAL NETWORKS

(71) Applicant: Microsoft Technology Licensing, LLC, Redmond, WA (US)

(72) Inventors: Qin Iris Wang, Cupertino, CA (US); Adam M. Myers, Sunnyvale, CA (US); Ningfeng Liang, Cupertino, CA (US); Mahesh Vishwanath, Cupertino, CA (US); Paul Ogden Fletcher, Sunnyvale, CA (US); Angela J. Jiang, San Mateo, CA (US); Shubham Anandani, Sunnyvale, CA (US); Warren E. Bartolome, San Jose, CA (US); Aayush Gopal Dawra, San Francisco, CA (US); Bef Ayenew, Fremont, CA (US); Kirill Alekseyevich Talanine, Sunnyvale, CA (US); Enrique Torrendell, San Francisco, CA (US); Charu Jangid, San Francisco, CA (US)

(73) Assignee: Microsoft Technology Licensing, LLC, Redmond, WA (US)

(21) Appl. No.: 15/721,025

(22) Filed: Sep. 29, 2017

Related U.S. Application Data
(60) Provisional application No. 62/561,546, filed on Sep. 21, 2017.

(51) Int. Cl. G06Q 10/10; G06Q 50/00; G06F 17/30

(52) U.S. Cl. CPC G06Q 10/1053; G06F 17/30864; G06Q 50/01

(57) ABSTRACT

The disclosed embodiments provide a system for improving use of a social network. During operation, the system identifies skills that are trending within a social network based on usage features associated with usage of the skills in the social network. Next, the system matches one or more of the skills to member features for a member of the social network. The system then outputs a recommendation of the skill(s) to the member.

### RELATED APPLICATION

This application claims priority under 35 U.S.C. section 119(e) to U.S. Provisional Application Ser. No. 62/561,546, entitled “Model-Based Recommendation of Trending Skills in Social Networks,” by inventors Qin Iris Wang, Adam M. Myers, Ningfeng Liang, Mahesh Vishwanath, Paul Ogden Fletcher, Angela J. Jiang, Shubham Anandani, Warren E. Bartolome, Aayush Gopal Dawra, Bef Ayenew, Kirill Alekseyevich Talanine, Enrique Torrendell and Charu Jangid, filed on 21 Sep. 2017.

### BACKGROUND

### Field

The disclosed embodiments relate to user recommendations. More specifically, the disclosed embodiments relate to techniques for performing model-based recommendation of trending skills in social networks.

### Related Art

Social networks may include nodes representing individuals and/or organizations, along with links between pairs of nodes that represent different types and/or levels of social familiarity between the nodes. For example, two nodes in a social network may be connected as friends, acquaintances, family members, classmates, and/or professional contacts. Social networks may further be tracked and/or maintained on web-based social networking services, such as online professional networks that allow the individuals and/or organizations to establish and maintain professional connections, list work and community experience, endorse and/or recommend one another, run advertising and marketing campaigns, promote products and/or services, and/or search and apply for jobs.

In turn, social networks and/or online professional networks may facilitate activities related to business, sales, recruiting, networking, professional growth, and/or career development. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for improving use of a social network in accordance with the disclosed embodiments.

FIG. 3 shows the recommendation of trending skills in a social network in accordance with the disclosed embodiments.

FIG. 4 shows a flowchart illustrating a process of recommending a trending skill in a social network in accordance with the disclosed embodiments.

FIG. 5 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

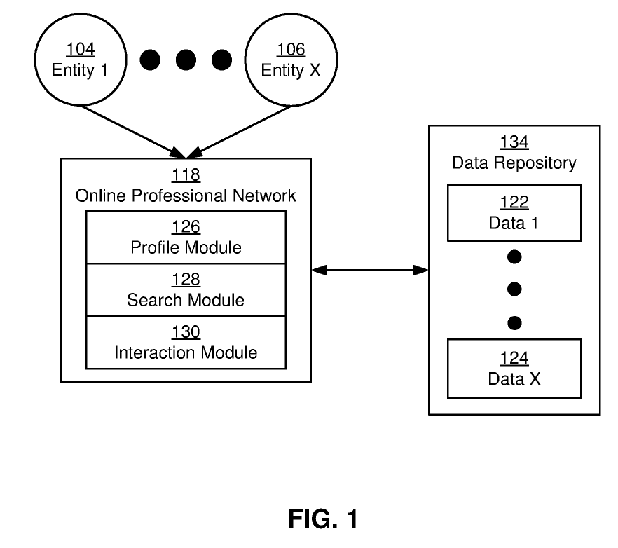

The disclosed embodiments provide a method, apparatus, and system for improving use of a social network or another community of users. As shown in FIG. 1, the social network may include an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

The entities may use a profile module 126 in online professional network 118 to create and edit profiles containing information related to the entities' professional and/or industry backgrounds, experiences, summaries, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience. As described in further detail below, such suggestions may improve the quality and completeness of the profiles, as well as the functionality of online professional network 118 for the entities.

The entities may use a search module 128 to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

The entities may also use an interaction module 130 to interact with other entities on online professional network 118. For example, interaction module 130 may allow an entity to add other entities as connections, follow other entities, send and receive messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest postings, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

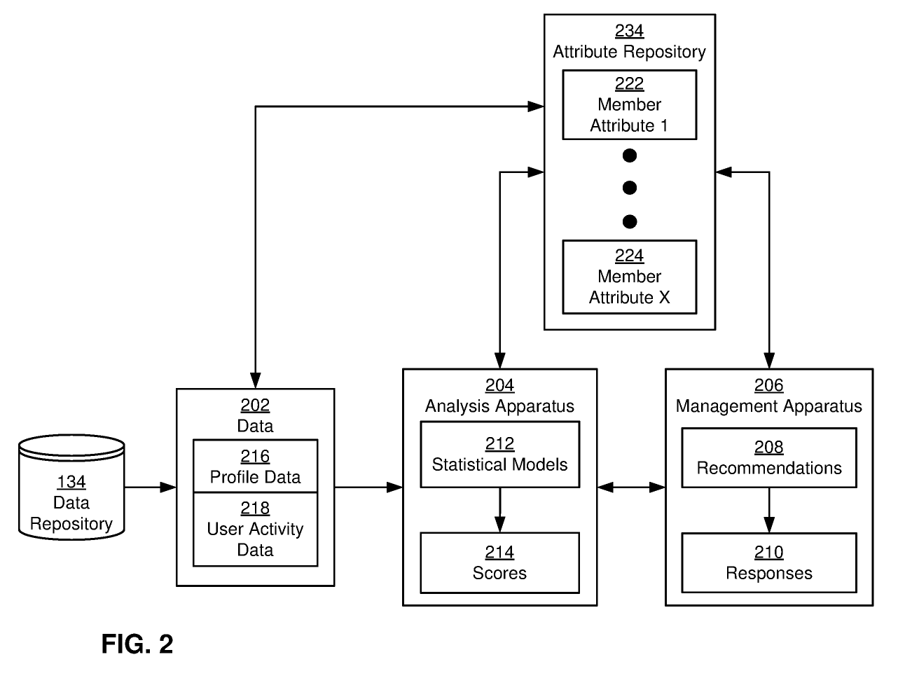

As shown in FIG. 2, data repository 134 and/or another primary data store may be queried for data 202 that includes profile data 216 for members of a social network (e.g., online professional network 118 of FIG. 1), as well as user activity data 218 that tracks the members' activity within and/or outside the social network. Profile data 216 may include data associated with member profiles in the social network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the social network.

Attributes of the members may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

User activity data 218 may include records of member interactions with one another and/or content associated with the social network. For example, user activity data 218 may be used to track impressions, clicks, likes, dislikes, shares, hides, comments, posts, updates, conversions, and/or other user interaction with content in the social network. User activity data 218 may also track other types of activity, including connections, messages, and/or interaction with groups or events Like profile data 216, user activity data 218 may be used to create a graph, with nodes in the graph representing social network members and/or content and edges between pairs of nodes indicating actions taken by members, such as creating or sharing articles or posts, sending messages, connection requests, joining groups, and/or following other entities.

In one or more embodiments, profile data 216 and user activity data 218 are used to improve the recommendation and/or use of member attributes (e.g., member attribute 1 222, member attribute x 224) found in member profiles of the members. The member attributes may include values of location, skills, titles, industries, companies, schools, summaries, publications, patents, and/or other fields in the member profiles. The member attributes may be extracted from profile data 216 in data repository 134 and/or an attribute repository 234 containing standardized member attributes.

Attribute repository 234 may store data that is used to standardize, organize, and/or classify member attributes in profile data 216. For example, skills in profile data 216 may be organized into a hierarchical taxonomy that is stored in attribute repository 234 and/or another repository. The taxonomy may model relationships between skills (e.g., “Java programming” is related to or a subset of “software engineering”) and/or standardize identical or highly related skills (e.g., “Java programming,” “Java development,” “Android development,” and “Java programming language” are standardized to “Java”).

As mentioned above, a profile module (e.g., profile module 126 of FIG. 1) in the social network may include functionality to recommend or suggest profile edits to the member's profiles. More specifically, a management apparatus 206 may generate a set of recommendations 208, with each recommendation containing one or more member attributes from attribute repository 234 that are determined to be relevant to the member profile of a given member. For example, management apparatus 206 may generate recommendations 208 based on existing fields in the member profile, relationships among member attributes in the taxonomy, the presence of the member attributes in member profiles of similar members and/or the member's connections, publicly available data, and/or other types of data or inference.

Management apparatus 206 and/or another component may display recommendations 208 within a graphical user interface (GUI) and/or application (e.g., web application, mobile application, native application, etc.) for accessing the social network. For example, recommendations 208 may be displayed within a content feed, profile-completion feature, recommendation feature, search feature, and/or another feature associated with the social network. Recommendations 208 may also, or instead, be delivered via email, a messaging service, one or more notifications, and/or another mechanism for communicating or interacting with the member.

Management apparatus 206 may also track responses 210 of the members to recommendations 208. For example, each member may have the option of accepting, rejecting, or ignoring a recommended member attribute. Management apparatus 206 may categorize the acceptances as positive responses, the rejections as negative responses, and the ignored recommendations as neutral or ambiguous responses to recommendations 208. Each response may be stored with an identifier of the corresponding member, an identifier of the recommendation to which the response was made, identifiers of one or more recommended member attributes in the recommendation, a timestamp of the response, and/or other data.

An analysis apparatus 204 may apply a number of statistical models 212 to profile data 216, user activity data 218, member attributes, and/or responses 210 to produce a number of scores 214 for assessing the quality of recommendations 208 and/or the associated member attributes. One set of scores 214 may represent the degree to which a given member attribute is trending, within or outside the social network. For example, analysis apparatus 204 may apply a statistical model to features associated with job postings, searches, member-added skills, and/or other profile data 216 or user activity data 218 to calculate, for each of some or all standardized skills in attribute repository 234, a score representing the degree to which the skill is trending in the social network.

In turn, scores 214 used to identify trending member attributes in the social network may be combined with a different set of scores 214 related to member acceptance of recommended member attributes. For example, analysis apparatus 204 may apply a different statistical model to features associated with the members, member attributes, and/or responses 210 to calculate a set of scores representing the members' propensities to accept recommendations 208 of the corresponding member attributes and/or the relevance of the member attributes to the members. The scores may include probabilities ranging from 0 (i.e., highly unlikely to accept a recommendation) to 100 (i.e., highly likely to accept the recommendation).

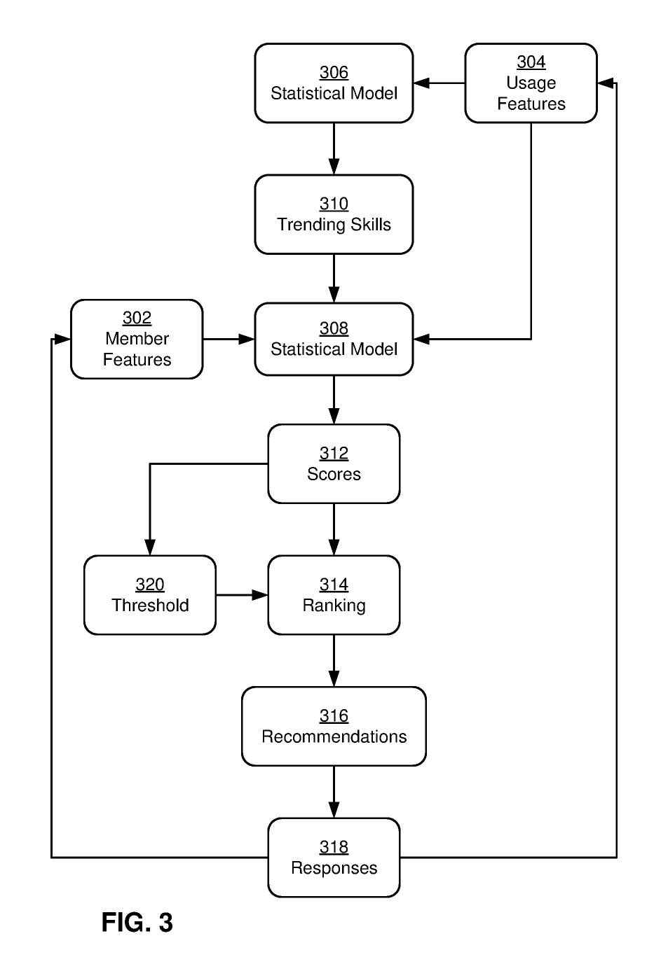

Scores 214 may then be used by management apparatus 206 to improve recommendations 208. For example, management apparatus 206 may select trending skills that are missing from member profiles and have predicted propensities that exceed a threshold for inclusion in recommendations 208, thereby increasing the relevance and/or usefulness of recommendations 208 to the members. Using trending skills and predicted propensities of accepting member attributes to generate recommendations of the member attributes is described in further detail below with respect to FIG. 3.

By improving recommendations 208 based on data 202 from data repository 134 and responses 210 to the recommendations, the system of FIG. 2 may allow member profiles in the social network to be more up-to-date, complete, and/or accurate. In turn, the system may increase the value of the social network to the members, the value provided by the members to the social network, and/or member engagement with the social network. Consequently, the system may improve technologies related to use of online social networks through network-enabled devices and/or applications, as well as user engagement and interaction through the social networks, network-enabled devices, and/or applications.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more filesystems, and/or a cloud computing system. Analysis apparatus 204 and management apparatus 206 may additionally be implemented together and/or separately by one or more hardware and/or software components and/or layers.

Second, a number of statistical models 212 and/or techniques may be used to generate scores 214. For example, the functionality of each statistical model may be provided by a regression model, artificial neural network, support vector machine, decision tree, random forest, gradient boosting tree, naïve Bayes classifier, Bayesian network, clustering technique, deep learning model, hierarchical model, and/or ensemble model.

Moreover, the same statistical model or separate statistical models may be used to generate scores for various members, member segments, member attributes, and/or types of member attributes in the social network. For example, one statistical model may be used to calculate scores that are used to identify trending member attributes, and a different statistical model may be used to calculate scores for predicting the members' propensities to accept recommendations of the member attributes. In a second example, a separate statistical model may be used to characterize and/or predict trending member attributes and/or the acceptance propensities of member attributes by a different member and/or member segment of the social network. In a third example, multiple statistical models may be used to generate scores 214 for different types of member attributes (e.g., skills, titles, industries, companies, schools, summaries, groups, etc.) in the social network. In a fourth example, the same statistical model may be used to identify, for a given member, one or more skills that are both trending in the social network and relevant to the member.

Third, profile data 216, user activity data 218, member attributes, responses 210, and/or other data used to generate scores 214 and/or recommendations 208 may be obtained from a variety of sources. As mentioned above, profile data 216, user activity data 218, member attributes, and/or responses 210 may be obtained and/or tracked within a social network. Alternatively, some or all of the data used to generate scores 214 and/or recommendations 208 may be obtained from other applications, user interactions, and/or public records.

FIG. 3 shows the recommendation of trending skills 310 in a social network in accordance with the disclosed embodiments. As described above, one or more statistical models 306-308 may be used to identify trending skills 310 and generate recommendations 316 of trending skills 310 to members of the social network.

More specifically, a first statistical model 306 may be used to identify trending skills 310 from usage features 304 associated with usage of skills in the social network. For example, statistical model 306 may include a regression model and/or deep learning model that classifies a skill as trending or not trending and/or scores the level of trending in the skill based on usage features 304 obtained from job listings, searches, skills added to member profiles, articles, posts, announcements, and/or other recent activity within or outside the social network. The usage features may include, but are not limited to, the number of times the skill and/or a standardized version of the skill is mentioned or found within each type of activity (e.g., job listing, search, member-added skills, articles, posts, announcements, etc.) over a given period (e.g., in the last 1-3 months).

In turn, the output of statistical model 306 may be used to identify trending skills 310 from a larger set of skills, such as a set of standardized skills used within the social network. For example, a threshold may be applied to scores outputted by statistical model 306 to identify trending skills 310 as those that are trending the most, within or outside the social network. The threshold may represent a pre-specified number or percentile of the highest scores, or the threshold may represent a minimum score required for a skill to be considered trending. In another example, statistical model 306 may classify a subset of standardized skills as trending skills 310 based on usage and/or occurrences of the skills in activity within or outside the social network.

Next, statistical model 308 may be used to match trending skills 310 to member features 302 for members of the social network. Member features 302 may include current and/or previous member attributes in the member profile of a member in a social network. For example, member features 302 may include the current and/or previous title, skills, work experience, education, seniority, industry, location, publications, certifications, patents, and/or other attributes listed in the member's profile with the social network. Because the member is likely to be connected to other members with similar attributes, member features 302 may also be supplemented with member attributes of the member's connections, such as skills, companies, schools, and/or industries of the connections.

Member features 302 may also include the member's number of connections and/or level of activity in the social network. The activity level may be binary (e.g., dormant or active), or the activity level may be calculated by aggregating different types of activities into an overall activity count and/or a bucketized activity score. Member features 302 may further include attributes that are specific to one or more features in the social network, such as a classification of the member as a job seeker, non-job-seeker, influencer, and/or non-influencer in an online professional network.

One or more member features 302 may also be used to identify a member segment in the social network. For example, the member's language, industry, title, and/or country may be used to define a member segment for the member. The member segment may be provided as input to statistical model 308, or a different version of the statistical model may be used to match trending skills 310 to a different member segment in the social network.

Input to statistical model 308 may include member features 302, a standardized form of one or more trending skills 310, and/or one or more usage features 304 associated with the skills. In turn, output from statistical model 308 may include one or more scores 312 that are used to match one or more trending skills 310 to the corresponding member(s) and/or member segments. For example, statistical model 308 may be a random forest and/or gradient boosted tree that uses a set of decision trees to generate a score from 0 to 100 representing the likelihood of a member in accepting a recommendation of a trending skill. A higher propensity score may indicate a higher chance of acceptance, and a lower propensity score may indicate a lower chance of acceptance. In another example, statistical model 308 may generate a score representing the relevance of a given trending skill to the member, with a higher score indicating a skill that is more relevant to the member and a lower skill indicating a skill that is less relevant to the member.

Statistical model 308 may be trained using member features 302, trending skills 310, and/or usage features 304 collected over a pre-specified period (e.g., the last six months), including member responses 318 to recommendations 316 over the period. Statistical model 308 may then be used to predict the members' responses to future recommendations of skills and/or other member attributes. For example, statistical model 308 may produce a different propensity and/or relevance score for each unique pair of member and trending skill.

Scores 312 may then be used to generate recommendations 316 of one or more trending skills 310 to a given member. First, a subset of trending skills 310 with scores 312 that are higher than a threshold 320 may be identified. For example, trending skills 310 with propensity and/or relevance scores that are higher than a pre-specified value and/or percentile may be identified.

Next, a ranking 314 of the identified subset of skills may be generated. For example, skills in the subset may be ranked in descending order of propensity and/or relevance, so that skills that are most likely to be accepted by the member are at the top of ranking 314 and skills that are least likely to be accepted by the member are at the bottom of ranking 314.

Ranking 314 may then be used to output recommendations 316 of trending skills 310 to the member. For example, one or more trending skills 310 that are missing from the member's profile may be recommended to the member in the order in which the skills appear in the ranking.

Each recommendation may identify the skill as both trending and relevant to the member. For example, a recommendation may be displayed to the member within a homepage, news feed, search module, profile module, and/or other part of the social network. The recommendation may also relate the skill to one or more attributes of the member (e.g., “this skill is in demand for people with your job title,” “your profile is missing a trending skill,” etc.).

Recommendations 316 may also provide additional information and/or actions related to the corresponding skills. For example, a recommendation may include a suggestion to learn a recommended skill that is accompanied by a link to a topic page for the skill, an online course for learning the skill, and/or other information related to the skill. In another example, the recommendation may include a usage statistic associated with the skill (e.g., “768 members in your network have this skill,” “345 members in your industry have recently added this skill,” “873 job postings this month have this skill,” “This skill has been found in 548 recruiter searches in the last month,” etc.). In a third example, the recommendation may present the skill as a suggested profile edit to the member. The member may click on the suggested profile edit to automatically add the skill to the member's profile.

The member's responses 318 to recommendations 316 may also be tracked and used to update member features 302, usage features 304, and/or statistical models 306-308. For example, the member's positive, negative, neutral, and/or ambiguous responses to recommended trending skills 310 may be used to tailor statistical models 306-308 and/or the content or format of recommendations 316 to the member and/or member segment. The performance of statistical models 306-308 may thus improve as user feedback to recommendations 316 is collected.

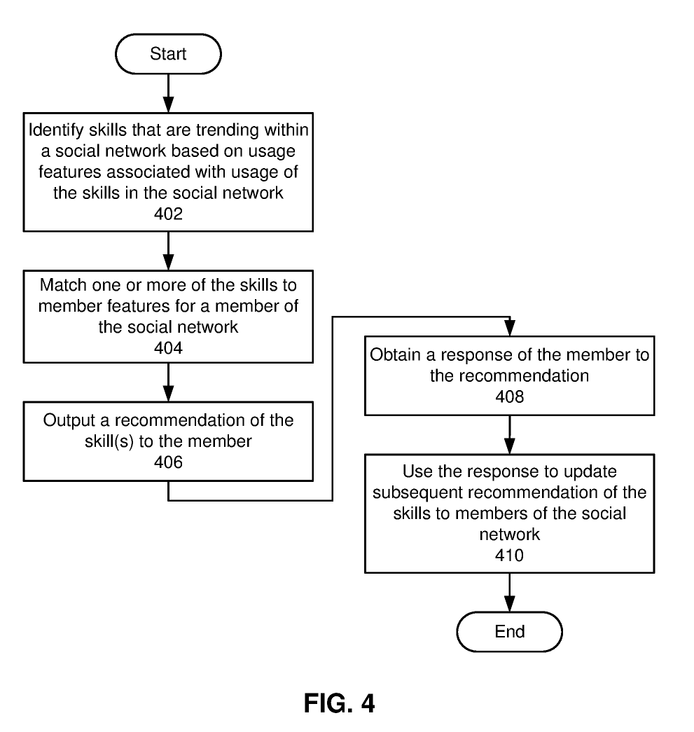

FIG. 4 shows a flowchart illustrating a process of recommending a trending skill in a social network in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, skills that are trending within the social network are identified based on usage features associated with usage of the skills in the social network (operation 402). For example, a statistical model may be applied to usage features that measure the occurrence of a given skill in job postings, searches of skills, profile updates, articles, posts, announcements, and/or other recent activity within or outside the social network. In turn, the statistical model may output a score indicating the level of trending of the skill, and a subset of the skills with the highest scores and/or skills with scores that exceed a threshold may be identified as trending skills.

Next, one or more of the skills are matched to member features for a member of a social network (operation 404). Continuing with the previous example, the same statistical model or a different statistical model may be applied to the member features to output a score representing a predicted propensity of the member in accepting a recommendation of a given trending skill and/or a relevance of the skill to the member. The member features may include, but are not limited to, an existing (e.g., current or previous) skill, title, industry, company, school, publication, certification, summary, and/or another profile attribute of the member. In turn, propensity scores outputted by the statistical model(s) may be used to identify one or more trending skills that the member is likely to accept as recommendations and select the trending skill(s) as recommendations for the member.

A recommendation of the skill(s) to the member is then outputted (operation 406). For example, the recommendation may be displayed to the member when the member accesses the social network, in an email to the member, and/or in another form of communication with the member. The recommendation may provide a usage statistic associated with the skill(s), a topic page for the skill(s), a course or learning plan for learning the skill, and/or a mechanism for adding the skill(s) to the member's profile.

A response of the member to the recommendation is also obtained (operation 408) and used to update subsequent recommendation of the skills to members of the social network (operation 410). For example, the member's acceptance, rejection, and/or lack of response to a recommended skill may be included in the usage features for the skill and/or member features for the member. The updated features may subsequently be used to identify trending skills, generate scores representing member propensities in accepting recommendations and/or relevance of skills to members, and/or select content (e.g., usage statistics, topic pages, profile edits, recommended actions, insights, etc.) to be included in recommendations of the skills. Operations 408-410 may be repeated in a feedback loop that continuously tracks the member's responses to recommended trending skills and updates subsequent recommendations accordingly. Thus, recommendations of trending skills for the member and/or other members may evolve or improve over time.

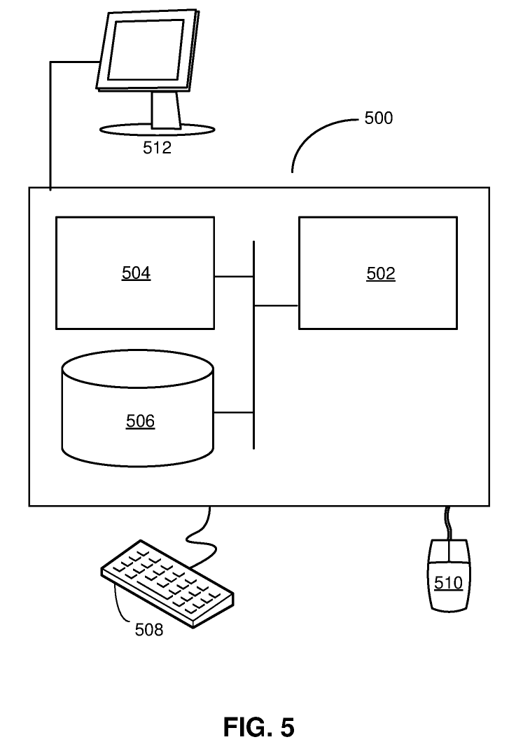

FIG. 5 shows a computer system 500 in accordance with the disclosed embodiments. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for improving use of a social network. The system includes an analysis apparatus and a management apparatus, one or both of which may alternatively be termed or implemented as a module, mechanism, or other type of system component. The analysis apparatus may identify skills that are trending within a social network based on usage features associated with usage of the skills, within or outside the social network. Next, the analysis apparatus may match one or more of the skills to member features for a member of the social network. The management apparatus may then output a recommendation of the one or more skills to the member.

In addition, one or more components of computer system 500 may be remotely located and connected to the other components over a network. Portions of the present embodiments (e.g., analysis apparatus, management apparatus, data repository, attribute repository, etc.) may also be located on different nodes of a distributed system that implements the embodiments. For example, the present embodiments may be implemented using a cloud computing system that recommends trending skills and/or other member attributes to a set of remote members of a social network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
identifying, by a computer system, skills that are trending within a social network based on usage features associated with usage of the skills in the social network;
selecting, by the computer system, one or more of the skills to recommend to a member of the social network by matching the one or more skills to member features for the member; and
outputting a recommendation of the one or more of the skills to the member.

2. The method of claim 1, further comprising:
obtaining a response of the member to the recommendation; and
using the response to update subsequent recommendation of the skills to additional members of the social network.

3. The method of claim 1, wherein identifying the skills that are trending within the social network comprises:
applying a statistical model to the usage features; and
obtaining, as output from the statistical model, a score indicating a level of trending in a skill.

4. The method of claim 1, wherein the usage features are obtained from job postings in the social network.

5. The method of claim 1, wherein the usage features are obtained from searches in the social network.

6. The method of claim 1, wherein the usage features are obtained from profile updates in the social network.

7. The method of claim 1, wherein selecting the one or more of the skills to recommend to the member of the social network comprises:
applying a statistical model to the member features; and
obtaining one or more scores as output from the statistical model; and
using the one or more scores to select the one or more skills to recommend to the member of the social network.

8. The method of claim 7, wherein the one or more scores represent at least one of:
a predicted propensity of the member in accepting the recommendation of the one or more skills; and
a relevance of the one or more skills to the member.

9. The method of claim 1, wherein the member features comprise at least one of:
an existing skill;
a title;
an industry;
a company;
a school;
a publication;
a certification; and
a summary.

10. The method of claim 1, wherein outputting the recommendation of the one or more of the skills to the member comprises:
including a usage statistic associated with a skill in the recommendation.

11. The method of claim 1, wherein outputting the recommendation of the one or more of the skills to the member comprises:
recommending a topic page for a skill to the member.

12. The method of claim 1, wherein outputting the recommendation of the one or more of the skills to the member comprises:
recommending a skill as a profile edit to the member.

13. A system, comprising:
one or more processors; and
memory storing instructions that, when executed by the one or more processors, cause the apparatus to:
identify skills that are trending within a social network based on usage features associated with usage of the skills in the social network;
select one or more of the skills to recommend to a member of the social network by matching the one or more skills to member features for the member; and
output a recommendation of the one or more of the skills to the member.

14. The system of claim 13, wherein the memory further stores instructions that, when executed by the one or more processors, cause the apparatus to:
obtain a response of the member to the recommendation; and
use the response to update subsequent recommendation of the skills to additional members of the social network.

15. The system of claim 13, wherein identifying the skills that are trending within the social network comprises:
applying a statistical model to the usage features; and
obtaining, as output from the statistical model, a score indicating a level of trending in a skill.

16. The system of claim 13, wherein the usage features are obtained from at least one of:
job postings;
searches; and
profile updates.

17. The system of claim 13, wherein selecting the one or more of the skills to recommend to the member of the social network comprises:
applying a statistical model to the member features; and
obtaining one or more scores as output from the statistical model; and
using the one or more scores to select the one or more skills to recommend to the member of the social network

18. The system of claim 17, wherein the one or more scores represent at least one of:
a predicted propensity of the member in accepting the recommendation of the one or more skills; and
a relevance of the one or more skills to the member.

19. The system of claim 13, wherein outputting the recommendation of the one or more of the skills to the member comprises at least one of:
including a usage statistic associated with a skill in the recommendation;
recommending a topic page for the skill;
recommending a course for learning the skill; and
recommending the skill as a profile edit.

20. A non-transitory computer-readable storage medium storing instructions that when executed by a computer cause the computer to perform a method, the method comprising:
identifying skills that are trending within a social network based on usage features associated with usage of the skills in the social network;
matching one or more of the skills to member features for a member of the social network; and
outputting a recommendation of the one or more of the skills to the member.
